(19) United States
(12) Patent Application Publication
(10) Pub. No.: US 2026/0016319 A1
(43) Pub. Date: Jan. 15, 2026

(54) TECHNIQUES FOR SENSOR CALIBRATION

(71) Applicant: Apple Inc., Cupertino, CA (US)

(72) Inventor: Mikael B. MANNBERG, San Jose, CA (US)

(21) Appl. No.: 19/009,441

(22) Filed: Jan. 3, 2025

Related U.S. Application Data
(60) Provisional application No. 63/671,372, filed on Jul. 15, 2024.

(51) Int. Cl. G01C 25/00

(52) U.S. Cl. CPC G01C 25/005

(57) ABSTRACT

The present disclosure generally relates to sensor calibration. Some techniques described herein are for calibrating a camera using a motion sensor.

### CROSS-REFERENCE TO RELATED APPLICATIONS

The present application claims priority to U.S. Provisional Patent Application Ser. No. 63/671,372, entitled “TECHNIQUES FOR SENSOR CALIBRATION” filed Jul. 15, 2024, which is hereby incorporated by reference in its entirety for all purposes.

### BACKGROUND

Electronic devices are becoming increasingly complex. For example, some electronic devices include different sensors at different locations and/or use sensor data received from remote sensors. Ensuring that such sensors are properly calibrated can be difficult. Accordingly, there is a need to improve techniques for sensor calibration.

### SUMMARY

Current techniques for sensor calibration are generally ineffective and/or inefficient. For example, some techniques require calibrating a sensor using another sensor of the same type, such as a lower-performance Inertial Measurement Unit (IMU) being calibrated using a higher-performance IMU. This disclosure provides more effective and/or efficient techniques for sensor calibration using an example of a camera being calibrated using an IMU. It should be recognized that other types of sensors can be calibrated and/or other types of sensors can be used to calibrate sensors using techniques described herein. For example, a camera can be used to calibrate a LiDAR sensor by comparing objects in a scene and using IMU data to bridge and/or constrain a calibration process using techniques described herein. In addition, techniques optionally complement or replace other techniques for sensor calibration.

In some embodiments, a method that is performed at a computer system that is in communication with (1) a first sensor and (2) a camera that includes a first image sensor and a second sensor different from the first sensor is described. In some embodiments, the method comprises: receiving, from the first sensor, first sensor data; receiving, from the second sensor of the camera, second sensor data; after receiving the first sensor data and the second sensor data, comparing the first sensor data with the second sensor data; and in response to comparing the first sensor data with the second sensor data, calibrating the camera.

In some embodiments, a non-transitory computer-readable storage medium storing one or more programs configured to be executed by one or more processors of a computer system that is in communication with (1) a first sensor and (2) a camera that includes a first image sensor and a second sensor different from the first sensor is described. In some embodiments, the one or more programs includes instructions for: receiving, from the first sensor, first sensor data; receiving, from the second sensor of the camera, second sensor data; after receiving the first sensor data and the second sensor data, comparing the first sensor data with the second sensor data; and in response to comparing the first sensor data with the second sensor data, calibrating the camera.

In some embodiments, a transitory computer-readable storage medium storing one or more programs configured to be executed by one or more processors of a computer system that is in communication with (1) a first sensor and (2) a camera that includes a first image sensor and a second sensor different from the first sensor is described. In some embodiments, the one or more programs includes instructions for: receiving, from the first sensor, first sensor data; receiving, from the second sensor of the camera, second sensor data; after receiving the first sensor data and the second sensor data, comparing the first sensor data with the second sensor data; and in response to comparing the first sensor data with the second sensor data, calibrating the camera.

In some embodiments, a computer system configured to communicate with (1) a first sensor and (2) a camera that includes a first image sensor and a second sensor different from the first sensor is described. In some embodiments, the computer system comprises one or more processors and memory storing one or more programs configured to be executed by the one or more processors. In some embodiments, the one or more programs includes instructions for: receiving, from the first sensor, first sensor data; receiving, from the second sensor of the camera, second sensor data; after receiving the first sensor data and the second sensor data, comparing the first sensor data with the second sensor data; and in response to comparing the first sensor data with the second sensor data, calibrating the camera.

In some embodiments, a computer system configured to communicate with (1) a first sensor and (2) a camera that includes a first image sensor and a second sensor different from the first sensor is described. In some embodiments, the computer system comprises means for performing each of the following steps: receiving, from the first sensor, first sensor data; receiving, from the second sensor of the camera, second sensor data; after receiving the first sensor data and the second sensor data, comparing the first sensor data with the second sensor data; and in response to comparing the first sensor data with the second sensor data, calibrating the camera.

In some embodiments, a computer program product is described. In some embodiments, the computer program product comprises one or more programs configured to be executed by one or more processors of a computer system that is in communication with (1) a first sensor and (2) a camera that includes a first image sensor and a second sensor different from the first sensor. In some embodiments, the one or more programs include instructions for: receiving, from the first sensor, first sensor data; receiving, from the second sensor of the camera, second sensor data; after receiving the first sensor data and the second sensor data, comparing the first sensor data with the second sensor data; and in response to comparing the first sensor data with the second sensor data, calibrating the camera.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system in accordance with some embodiments.

FIG. 2 is a block diagram illustrating a device with interconnected subsystems in accordance with some embodiments.

FIG. 3 is a block diagram of a device in accordance with some embodiments.

FIG. 4 is a flow diagram illustrating a method for sensor calibration in accordance with some embodiments.

### DETAILED DESCRIPTION

The examples, descriptions, and elements disclosed within are laid out as potential embodiments to describe and expand on the claimed subject matter. It should be recognized that such examples and embodiments are not intended as limiting on the scope of the disclosure but instead are provided as a description of the claimed subject matter.

The methods disclosed herein can include one or more steps that are contingent upon one or more conditions being satisfied. It should be understood that a method can occur over multiple iterations of the same process with different steps of the method being satisfied in different iterations. A person having ordinary skill in the art would also understand that similar to a method with contingent steps, a system or computer readable storage medium can repeat the steps of a method as many times as needed to ensure that all of the contingent steps have been performed. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied.

Additionally, the methods described can be rewritten as repeating until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied.

The present disclosure utilizes numerical descriptors to organize elements without introducing numerous unique identifiers. For example, the terms “first,” “second,” “third,” etc. are utilized to differentiate between like elements. However, such numbering techniques are not used to be limiting, neither denote quantity nor order. For example, a first computing system could be termed a second computing system, and, without departing from the scope of the disclosure, the first computing system could be termed a computing system. Additionally, in some embodiments, the first computing system and the second computing system are two separate references to the same computing system. Alternatively, in some embodiments, the first computing system and the second computing system can be distinct computing system of the same type of computing system or different type of computing systems.

When describing particular embodiments within the present disclosure, the descriptions are enclosed for the purpose of providing clear examples and not for limiting purposes. The description of various embodiments and appended claims include the following singular terminology “a,” “an,” and “the.” However, such terminology is intended to include the plural forms as well, unless clearly stated otherwise. Additionally, the use of “and/or” should be understood as including any and all combinations of the associated listed elements. For example, “A and/or B” includes “A,” “B,” and “A and B.” The use of the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The present disclosure can include conditional language. When using the term “if,” it should be, optionally, construed to mean “when,” “upon,” “in response to determining,” “in response to detecting,” or “in accordance with a determination that” depending on the context. Additionally, when using the phrase “if it is determined” or “if [a stated condition or event] is detected” it should be, optionally, construed to mean “upon determining,” “in response to determining,” “upon detecting [the stated condition or event],” “in response to detecting [the stated condition or event],” or “in accordance with a determination that [the stated condition or event]” depending on the context.

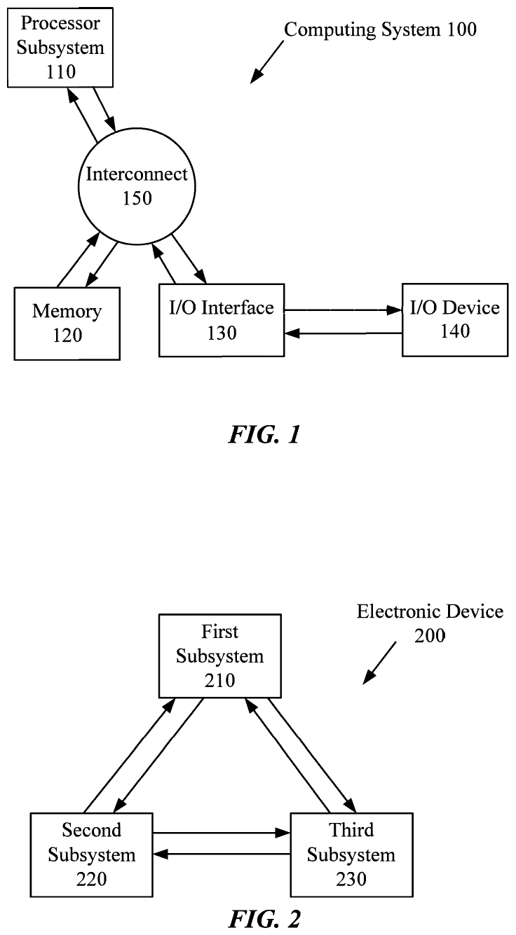

At FIG. 1, computing system 100 is illustrated through a block diagram, including a set of components. In the present disclosure, computing system 100 is used for exemplary purposes and should not be construed as limiting to one type of computing system or to one computer architecture of a computing system. The methods herein can be performed by other computer architectures and other computing systems. Computing system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. Although a single computing system is shown in FIG. 1, computing system 100 can also be implemented as two or more computing systems operating together.

In some embodiments, computing system 100 is included, connected to, or in communication with a physical component for the purpose of modifying the physical component in response to an instruction. Alternatively, in some embodiments, an instruction is received by computing system 100, and in response to the instruction, computing system 100 modifies the physical component. Computing system 100 can, but is not limited to, modify the following physical components: an acceleration control, a break, a gear box, a vacuum system, a motor, a pump, a refrigeration system, a steering control, a pump, a spring, a suspension system, a hinge, and/or a valve. In some embodiments, the physical component is modified via an algorithm, another computing system, an electric signal, and/or actuator.

In some embodiments, computing system 100 includes one or more sensors. In some embodiments, computing system 100 is a sensor. In some embodiments, a sensor includes one or more components designed to obtain information about an environment. In some embodiments, a sensor can be configured to obtain information within its proximity, to obtain information through contact with the environment or an object within the environment, or to obtain information from a specified direction originating from the sensor. Some exemplary sensor components include: a flow sensor, a force sensor, a temperature sensor, a time-of-flight sensor, a leak sensor, a level sensor, a light detection and ranging system, a gas sensor, a humidity sensor, an image sensor (e.g., a radar sensor, a camera sensor, and/or a LiDAR sensor), an angle sensor, a chemical sensor, a brake pressure sensor, a contact sensor, a non-contact sensor, an electrical sensor, an inertial measurement unit, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a metal sensor, a motion sensor, a torque sensor, and an ultrasonic sensor. In some examples, a sensor includes a combination of multiple sensors. In some embodiments, sensor data is captured by fusing data from one sensor with data from one or more other sensors. In some embodiments, a sensor can include one or more components such as a sensing component (e.g., an image sensor or temperature sensor), a transmitting component (e.g., a laser or radio transmitter), a receiving component (e.g., a laser or radio receiver), or any combination thereof.

In the current embodiment, computing system 100 includes multiple subsystems that are connected to and in communication with each other. Through interconnect 150 (e.g., a system bus, one or more memory locations, or other communication channel for connecting multiple components of computing system 100), processor subsystem 110 can communicate with (e.g., wired and/or wirelessly) memory 120 (e.g., system memory, dynamic memory, and/or virtual memory) and I/O interface 130. In some examples, multiple instances of processor subsystem 110 can be communicating via interconnect 150. Additionally, computing system 110 can communicate with additional components (e.g., I/O device 140) through I/O interface 130. In some embodiments, I/O interface 130 is included with I/O device 140 such that the two are a single component. It should be recognized that there can be one or more I/O interfaces, with each I/O interface communicating with one or more I/O devices.

Processor subsystem 110 enables computing system 100 to execute instructions to perform the exemplary disclosure laid out herein. For example, processor subsystem 110 can execute an operating system, a middleware system, one or more applications, or any combination thereof. In some embodiments, processor subsystem 110 includes one or more processors or processing units.

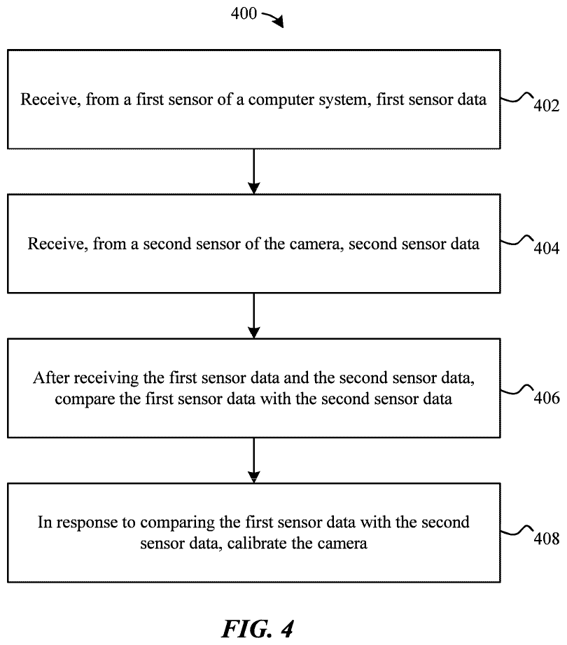

In some embodiments, the instructions required to perform the operations described herein are stored in memory 120 (e.g., through a connected non-transitory or transitory computer readable medium). Computing system 100 can use memory 120 to store (e.g., configured to store, assigned to store, and/or that stores) program instructions executable by processor subsystem 110. For example, memory 120 can store program instructions to implement the functionality associated with methods 400 (FIG. 4) described below.

Computing system 100 can utilize a variety of types of memory for storing instructions. In some embodiments, memory 120 can be implemented using different physical, non-transitory memory media, such as flash memory, random access memory (RAM-SRAM, EDO RAM, SDRAM, DDR SDRAM, RAMBUS RAM, or the like), hard disk storage, floppy disk storage, removable disk storage, read only memory (PROM, EEPROM, or the like), or the like.

In some embodiments, computing system 100 is not limited to memory 120 for storage. Computing system 100 can also include other forms of storage such as cache memory in processor subsystem 110 and non-processor storage through I/O interface 130 on I/O device 140 (e.g., a hard drive, storage array, etc.). In some embodiments, instructions to be executed by processor subsystem 110 to perform operations described herein can be stored on these other forms of storage. In some examples, processor subsystem 110 (or each processor within processor subsystem 110) contains a cache or other form of on-board memory.

Computing system 100 utilizes I/O interface 130 to communicate with other devices. In some embodiments, interface 130 includes various types of interfaces configured to effectively communicate with other devices. In some examples, I/O interface 130 includes a bridge chip (e.g., Southbridge) from a front-side bus to one or more back-side buses. In some embodiments, computing system 100 includes one or more I/O interfaces. In some embodiments, I/O interface 130 is capable of communicating with one or more I/O devices (e.g., I/O device 140) via one or more corresponding buses or other interfaces.

I/O devices provide additional functionality to computing system 100 through the associate hardware components included in the I/O device. Some examples of possible I/O devices include: output devices (e.g., auditory, tactile, or visual) (e.g., speaker, light, screen, projector, or the like); network interface devices (e.g., to a local or wide-area network), sensor devices (e.g., camera, ultrasonic sensor, GPS, radar, LiDAR, inertial measurement device, or the like); and storage devices (removable flash drive, storage array, hard drive, optical drive, SAN, or their associated controller). In some embodiments, computing system 100 is communicating with a network via a network interface device (e.g., configured to communicate over Wi-Fi, Bluetooth, Ethernet, or the like). In some embodiments, computing system 100 is directly or wired to the network. In some embodiments, computing system 100 is connected to I/O device 140 through a network connection (e.g., wired and/or wirelessly).

In some embodiments, computing system 100 includes an operating system to manage resources and hardware capabilities. Computing system 100 is compatible with, but not limited to, the following types of operating systems: distributed operating systems (e.g., Advanced Interactive executive (AIX), batch operating systems (e.g., Multiple Virtual Storage (MVS)), time-sharing operating systems (e.g., Unix), network operating systems (e.g., Microsoft Windows Server), and real-time operating systems (e.g., QNX). In some embodiments, the operating system provides additional capabilities to computing system 100 such as various procedures, sets of instructions, software components, and/or drivers for controlling and managing general system tasks (e.g., memory management, storage device control, power management, or the like) and for facilitating communication between hardware and software components. In some embodiments, the operating system controls the order and timing of the tasks to be executed by processor subsystem 110 through a priority-based scheduler. In such embodiments, the priority assigned to a task is used to identify a next task to execute. In some embodiments, the highest priority task runs to completion unless another higher priority task is made ready. In some embodiments, the priority-based scheduler identifies a next task to execute when a previous task finishes executing.

In some embodiments, computing system 100 includes a middleware system to provides one or more services and/or capabilities to applications (e.g., the one or more applications running on processor subsystem 110) outside of what the operating system offers (e.g., authentication, API management, data management, application services, messaging, or the like). In such embodiments, the middleware system can be configured to provide for implementation of commonly used functionality, message-passing between processes, package management, a heterogeneous computer cluster to provide hardware abstraction, low-level device control, or any combination thereof. Examples of middleware systems include, but are not limited to, Robot Operating System (ROS), Lightweight Communications and Marshalling (LCM), PX4, and ZeroMQ.

In some embodiments, the middleware system represents processes and/or operations using a graph architecture. In such embodiments, processing takes place in nodes that can receive, post, and multiplex state messages, planning messages, actuator messages, sensor data messages, control messages, and other messages. In such examples, the graph architecture can define an application (e.g., an application executing on processor subsystem 110 as described above) such that different operations of the application are included with different nodes in the graph architecture.

In some embodiments, a publish-subscribe model is used to provide communication between a first node in a graph architecture to a second node in the graph architecture. In such embodiments, the first node publishes data on a channel in which the second node can subscribe. In some embodiments, the first node can store data in memory (e.g., memory 120 or some local memory of processor subsystem 110) and send an acknowledgement to the second node that the data has been stored in memory. In some embodiments, the first node provides a pointer (e.g., a memory pointer, such as an identification of a memory location) to the second node so that the second node can directly access the memory location where the first node stored the data. In some embodiments, the first node does not need to store the data in memory and provides the second node the data directly, as to not require memory access (e.g., by the first node or the second node).

FIG. 2 illustrates a block diagram of electronic device 200 with interconnected subsystems. In the illustrated embodiment, electronic device 200 includes three different subsystems (i.e., first subsystem 210, second subsystem 220, and third subsystem 230). The subsystems of electronic device 200 are in communication with (e.g., wired or wirelessly) each other, and create a network (e.g., a storage area network, an enterprise internal private network, a campus area network, a personal area network, a local area network, a virtual private network, a wireless local area network, a metropolitan area network, a wide area network, a system area network, and/or a controller area network). Each subsystem of electronic device 200 can be configured or designed with the computer architecture as described in FIG. 1 (i.e., computing system 100). Additionally, while in the illustrated embodiment electronic device 200 contains three subsystems, electronic device 200 can be configured with additional or fewer subsystems.

In some embodiments, electronic device 200 includes alternative layouts or connectivity of electronic device 200's included subsystems. For example, first subsystem 210 connected to second subsystem 220 but not third subsystem 230, or second subsystem 220 connected to third subsystem 230 but not first subsystem 210. In some embodiments, electronic device 200's subsystems are electrically connected while additional subsystems are wireless connected to electronic device 200. In some embodiments, subsystems of electronic device 200 are configured to send messages between and receive messages from other subsystems of electronic device 200. In some embodiments, the subsystems can be configured to communicate wirelessly to the one or more computer systems outside of device 200. In such embodiments, one or more subsystems are wirelessly connected to one or more computer systems outside of device 200, such as a server system.

In some embodiments, one or more subsystems of electronic device 200 are used to control, manage, and/or receive data from one or more other subsystems of electronic device 200 and/or one or more additional computer systems (e.g., electrically connected or remote from electronic device 200). For example, first subsystem 210 and second subsystem 220 can each be a camera that captures images, and third subsystem 230 can use the captured images for decision making. In some embodiments, at least a portion of electronic device 200 functions as a distributed computer system. For example, a first portion of a task is executed by first subsystem 210 and a second portion of the task is executed by second subsystem 220.

In some embodiments, electronic device 200 includes an enclosure that fully or partially houses electronic device 200's subsystems (e.g., subsystems 210-230). Potential enclosures include, but are not limited to, a head-mounted-display device, a smart display, a home-appliance device (e.g., a refrigerator or an air conditioning system), an accessory device, a smart phone, a smart watch, a robot (e.g., a robotic arm or a robotic vacuum), and a vehicle. In some embodiments, electronic device 200 is capable of navigating a physical environment with or without user input.

Attention is now directed towards techniques for sensor calibration. Such techniques are described in the context of a device that includes (1) a camera with a lower-performance IMU and (2) a separate higher-performance IMU. It should be recognized that other types of components, electronic devices, and/or systems can be used with techniques described herein. For example, a device that includes a camera with a lower-performance IMU can be calibrated using another device with a higher-performance IMU using techniques described herein. In addition, techniques optionally complement or replace other techniques for sensor calibration.

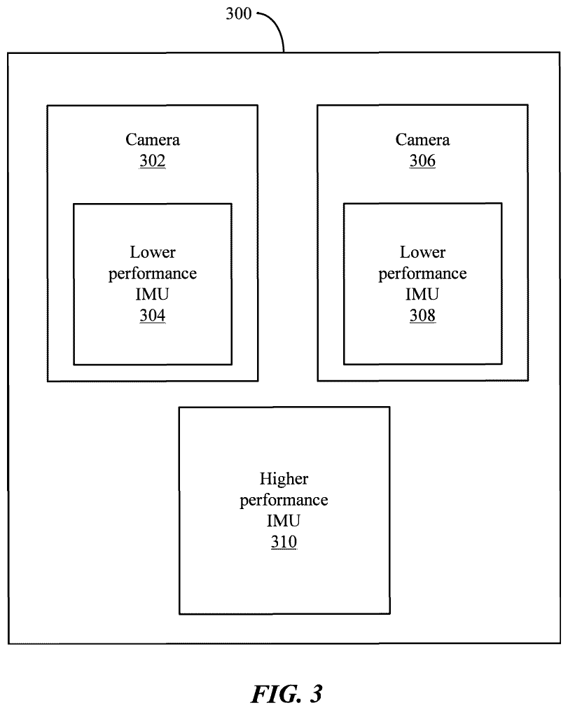

FIG. 3 is a block diagram of a device (e.g., device 300) in accordance with some embodiments. In some embodiments, device 300 is a watch, a phone, a tablet, a fitness tracking device, a processor, a head-mounted display (HMD) device, a communal device, a robot, a media device, a speaker, a television, a vehicle, or a personal computing device. Device 300 is used to describe the processes described below, including the processes in FIG. 4.

As illustrated in FIG. 3, device 300 includes multiple cameras (e.g., camera 302 and camera 306) and higher-performance IMU 310 (e.g., the multiple cameras and/or higher-performance IMU 310 are each within and/or physically coupled to a housing of device 300). In some embodiments, higher-performance IMU 310 is separate from the multiple cameras such that higher-performance IMU is not within and/or physically coupled to either of the multiple cameras.

As illustrated in FIG. 3, each of the multiple cameras also includes a lower-performance IMU (e.g., lower-performance IMU 304 of camera 304 and lower-performance IMU 308 of camera 306) (e.g., the lower-performance IMUs are each within and/or physically coupled to a housing of a camera). In some embodiments, lower performance IMU 304 is located at a position of device 300 that is near (e.g., within 1 inch to 2 feet) and/or within camera 302. In some embodiments, lower performance IMU 308 is located at a position of device 300 that is near (e.g., within 1 inch to 2 feet) and/or within camera 306. In some embodiments, lower performance IMU 304 is located at a position of device 300 that is near (e.g., within 1 inch to 2 feet) and/or within camera 302. In some embodiments, lower performance IMU 304 and lower performance IMU 308 are located at a position of device 300 that is not near (e.g., within 1 inch to 2 feet) and/or not within camera 302 and/or camera 306. In some embodiments, lower-performance IMU 304 and/or lower-performance IMU 308 are lower performance than higher-performance IMU 310. Examples of lower performance include additional noise, less measurement stability, less thermal stability, less bandwidth, less rate at which sensor data is detected, and/or less accuracy of sensor data that is detected.

With the above context, camera 302 can be calibrated by comparing sensor data detected via lower-performance IMU 304 and sensor data detected via higher-performance IMU 310. Similarly, camera 306 can be calibrated by comparing sensor data detected via lower-performance IMU 308 and sensor data detected via higher-performance IMU 310. Such calibration can include intrinsic (e.g., a parameter corresponding to a lens assembly and/or a camera module of camera 302) and/or extrinsic (e.g., a position relative to another position) calibration of camera 306. In some embodiments, calibration of camera 302 starts with calibration of lower-performance IMU 304 using higher-performance IMU 310 and then proceeds to calibration of camera 304 using lower-performance IMU 304. For example, lower-performance IMU 304 can be calibrated using sensor data detected via higher-performance IMU 310 to adjust for errors with and/or inaccuracies of sensor data detected via lower-performance IMU 304. Such calibration can be intrinsic and/or extrinsic calibration. After calibrating lower-performance IMU 304, camera 302 can be calibrated using sensor data detected via lower-performance IMU 304 to adjust a known position (e.g., location and/or orientation) of camera 302 with reference and/or relative to another location and/or component. For example, the known position of camera 302 can be adjusted with reference to camera 306 and/or lower performance IMU 308 such that calibrating the known position of camera 302 includes using a position of lower-performance IMU 304 as the known position of camera 302 and a position of lower-performance IMU 308 as a known position of camera 306. For another example, the known position of camera 302 can be adjusted with reference and/or relative to an arbitrary position (e.g., a position within device 300 other than where an IMU is located) such that calibrating the known position of camera 302 includes using the position of lower-performance IMU 304 as the known position of camera 302 and interpolating a position of the arbitrary position using the position of higher-performance IMU 310, the position of lower-performance IMU 304, the position of lower-performance IMU 308, and/or a position of another component configured to detect a position of the other component. In some embodiments, the arbitrary position is with reference to a position of device 300, such as a portion of a frame or housing of device 300 and/or another component of device 300 (such as a component that is not able to detect position of the component). Such calibration of camera 302 with reference and/or relative to another location and/or component can be extrinsic calibration to adjust for movement of camera 302 during operation that would cause images and/or video captured by camera 302 to be from a different perspective than expected.

In one example of some techniques described above, lower-performance IMU 304 detects sensor data (e.g., IMU data). In conjunction with lower-performance IMU 304 detecting sensor data, higher-performance IMU 310 detects sensor data (e.g., IMU data). The sensor data of higher-performance IMU 310 is used to determine whether there is an error with the sensor data of lower-performance IMU 304. For example, it can be determined that there is an error with the sensor data of lower-performance IMU 304 when the sensor data of lower-performance IMU 304 is not within an expected threshold of the sensor data of higher-performance IMU 310. After and/or without calibrating lower-performance IMU 304 using sensor data of higher-performance IMU 310, a current position of lower-performance IMU 304 can be compared to a previous position of lower-performance IMU 304 to determine whether lower-performance IMU 304 and/or camera 302 has moved since the previous position of lower-performance IMU 304 was determined. If lower-performance IMU 304 and/or camera 302 has moved since the previous position of lower-performance IMU 304, such movement can be taken into account with operations performed using sensor data of lower-performance IMU 304 (e.g., IMU data) and/or camera 302 (e.g., an image and/or a video). For example, when calculating a position of an object within a field of view of camera 302 (e.g., in an image and/or a video captured by camera 302), the movement of lower-performance IMU 304 and/or camera 302 can be used when determining the position of the object within the field of view of camera 302 with respect to device 300 without requiring a visual calibration using sensor data (e.g., an image or a video) captured by camera 302. Similar to above, after and/or without calibrating lower-performance IMU 304 using sensor data of higher-performance IMU 310, a current position of lower-performance IMU 304 can be compared to a current position of lower-performance IMU 308 to determine whether lower-performance IMU 304 and/or camera 302 has moved with respect to lower-performance IMU 308 and/or camera 306. Similar to above, after and/or without calibrating lower-performance IMU 304 using sensor data of higher-performance IMU 310, a current position of lower-performance IMU 304 can be compared to a current position of an IMU near and/or within a housing of another type of sensor (e.g., a LiDAR sensor, a temperature sensor, a microphone, and/or a radar sensor) to determine whether camera 302 has moved with respect to the other type of sensor. Similar to above, after and/or without calibrating lower-performance IMU 304 using sensor data of higher-performance IMU 310, a current position of lower-performance IMU 304 can be compared to an interpolated position of a point of device 300 that does not include a component configured to detect a position of the component to determine whether camera 302 has moved with respect to the interpolated position. For example, movement of camera 302 relative to higher-performance IMU 310 can be assumed to cause similar movement of camera 302 relative to the interpolated position.

In some embodiments, the calibration described above (sometimes referred to as IMU calibration) is performed in conjunction with and/or in combination to visual calibration of camera 302. For example, the visual calibration can include camera 302 and camera 306 each capturing an image and/or a video of a scene so that the image and/or the video of the scene from camera 302 can be compared to the image and/or the video of the scene from camera 306 to determine whether visual aspects indicate that camera 302 and/or camera 306 has moved (e.g., an object within the scene captured in an image from camera 302 can be expected to be at a particular position in an image from camera 306 such that any differences can be used to assume a change in relative position of camera 302 and camera 306). In such embodiments, the IMU calibration can be used when the visual calibration is not able to be performed (e.g., unable to identify a corresponding object within content captured by camera 302 and/or camera 306) and/or to refine the visual calibration (e.g., by providing another point of reference other than content captured by each camera). For example, the IMUs (e.g., lower-performance IMU 308 and higher-performance IMU 310) can continue performing extrinsic calibration between the IMUs (and thus camera 302 and camera 306) over a period of time when there is no visual information available for vision-based calibration. This can ensure that when visual information is accessible, the cameras are already calibrated and ready to operate at higher performance without needing to run a new vision-based calibration.

In some embodiments, the visual and/or IMU calibration occurs at different times during operation and/or the life of device 300, camera 302, and/or camera 306. In such embodiments, positions of different components can be tracked over time using the same or different types of calibration so that such calibration can continue to be used in different contexts (e.g., low light, high light, movement, no movement, and/or while device 300 is in different orientations). For example, during movement, extrinsic and/or intrinsic calibration of an IMU and/or a camera can be performed while, during no movement, bias calibration of an IMU can be performed.

In some embodiments, the visual and/or IMU calibration occurs in response to detecting an event has occurred, such as high frequency motion (e.g., detected via lower-performance IMU 304, lower-performance IMU 308, higher-performance IMU 310, and/or another component of and/or in communication with device 300) such as hitting a bump or high acceleration.

It should be recognized that (1) different types of sensors than described above can be used with techniques described herein and/or (2) components (e.g., camera 302, lower-performance IMU 304, camera 306, lower-performance IMU 308, and/or higher-performance IMU 310) can be in different configurations (e.g., included in other devices (e.g., other than device 300) that are in communication with device 300) than described above. For example, camera 302 with lower-performance IMU 304 can be included in a HMD device and higher-performance IMU 310 can be included in another device in communication with the HMD device such as a watch, a phone, and/or a battery pack for the HMD device. In such an example, the HMD device can include a lower-cost, less-complex-integration, and/or lighter-weight IMU (e.g., lower-performance IMU 304) while leveraging a higher-cost, more-complex-integration and/or heavier IMU (e.g., higher-performance IMU 310) of the other device. For another example, higher-performance IMU 310 can be replaced with another type of sensor (e.g., a camera and/or other type of sensor able to detect motion) with techniques described herein. In some embodiments, higher-performance IMU 310 can be calibrated by other external sensors that are not used to calibrate lower-performance IMU 308. For example, an IMU of a smart phone can be kept calibrated continuously, using magnetometer, camera, and/or GNSS. In such an example, techniques can leverage a lower performance but better calibrated IMU as a reference IMU to which all other sensors are calibrated.

FIG. 4 is a flow diagram illustrating a method (e.g., method 400) for sensor calibration in accordance with some embodiments. Some operations in method 400 are, optionally, combined, the orders of some operations are, optionally, changed, and some operations are, optionally, omitted.

In some embodiments, method 400 is performed at a computer system (and/or a device, such as a user device and/or a personal device of a user) (e.g., 100, 200, and/or 300) that is in communication with (and/or includes) a first sensor (e.g., as described above with respect to FIG. 1) (e.g., 310) and a camera (e.g., a periscope camera, a telephoto camera, a wide-angle camera, and/or an ultra-wide-angle camera) (e.g., 302 and/or 306) that includes a first image sensor (e.g., different from the first sensor) and a second sensor (e.g., as described above with respect to FIG. 1) (e.g., 304 and/or 308) different from the first sensor (and/or the first image sensor), wherein the first sensor and the second sensor do not include (and/or are not) an image sensor. In some embodiments, the computer system is a watch, a phone, a tablet, a fitness tracking device, a processor, a head-mounted display (HMD) device, a communal device, a media device, a speaker, a television, and/or a personal computing device. In some embodiments, the first sensor and/or the second sensor is an Inertial Measurement Unit (IMU). In some embodiments, the first sensor and/or the second sensor includes an accelerometer, a gyroscope, and/or a magnetometer. In some embodiments, the second sensor is the same type of sensor as the first sensor. In some embodiments, the second sensor is a different type of sensor than the first sensor. In some embodiments, the camera does not include the first sensor. In some embodiments, the second sensor is separate from and/or located at a different location (e.g., at least 6 inches-10 feet) than the first sensor. In some embodiments, the second sensor is less accurate than the first sensor. In some embodiments, sensor data detected via the second sensor is less accurate than sensor data detected via the first sensor. In some embodiments, the computer system includes the first sensor and does not include the camera. In some embodiments, the computer system does not include the first sensor and/or the camera. In some embodiments, the computer system is an HMD device (e.g., that is worn on a head of a user) and the camera is included in the HMD device. In such embodiments, the first sensor can be on another device (e.g., a watch, a phone, and/or a battery pack (e.g., for the HMD device)). In some embodiments, the first sensor is in a different housing than the camera. In some embodiments, the first sensor is in the same housing as the camera. In some embodiments, the first sensor is a camera, an image sensor, and/or other sensor (e.g., an IMU or a sensor other than an IMU). In some embodiments, the first sensor is configured to be able to detect motion of the camera. ISE the first sensor detects motion of the camera.

The computer system receives (402), from the first sensor (e.g., and not from the second sensor of the camera), (e.g., detects, via the first sensor) first sensor data (e.g., time-series and/or non-time-series data) (e.g., while the computer system is moving). In some embodiments, the first sensor data includes force data, angular rate data, and/or orientation data. In some embodiments, the force data of the first sensor data corresponds to (and/or is) an amount of force applied to the first sensor. In some embodiments, the angular rate data of the first sensor data corresponds to (and/or is) an angular rate of the first sensor. In some embodiments, the orientation data of the first sensor data corresponds to (and/or is) an orientation of the first sensor (e.g., with respect to another object (e.g., the computer system, the camera, the second sensor, and/or another object)). In some embodiments, the first sensor data does not correspond to the camera. In some embodiments, the first sensor data includes and/or is IMU data. In some embodiments, the first sensor detects the first sensor data while the computer system is moving.

The computer system receives (404), from the second sensor of the camera (e.g., and not from the first sensor), (e.g., detects, via the second sensor) second sensor data (e.g., time-series and/or non-time-series data) (e.g., while the computer system is moving). In some embodiments, the second sensor data includes force data, angular rate data, and/or orientation data. In some embodiments, the force data of the second sensor data corresponds to (and/or is) an amount of force applied to the second sensor, the first image sensor, and/or the camera. In some embodiments, the angular rate data of the second sensor data corresponds to (and/or is) an angular rate of the second sensor, the first image sensor, and/or the camera. In some embodiments, the orientation data of the second sensor data corresponds to (and/or is) an orientation of the second sensor, the first image sensor, and/or the camera (e.g., with respect to another object (e.g., the computer system, the first sensor, and/or another object)). In some embodiments, the second sensor data corresponds to and/or is associated with the camera and/or the first image sensor. In some embodiments, the second sensor data includes and/or is IMU data. In some embodiments, the second sensor detects the second sensor data while the computer system is moving. In some embodiments, the first sensor data and/or the second sensor data is not image and/or video data. In some embodiments, the first sensor and/or the second sensor is a different type of sensor (e.g., detects a different type of data) than the first image sensor.

After receiving the first sensor data and the second sensor data (and/or in response to receiving the first sensor data or the second sensor data), the computer system compares (406) the first sensor data with (and/or to) the second sensor data (e.g., to determine a position (e.g., location and/or orientation) of the camera and/or the first image sensor with respect to the first sensor and/or a previous position of the camera and/or the first image sensor).

In response to comparing the first sensor data with the second sensor data, the computer system calibrates (408) (e.g., based on comparing the first sensor data with the second sensor data) the camera (and/or the first image sensor) (e.g., with respect to the first sensor, the second sensor, and/or a frame of a vehicle and/or the computer system) (and not calibrating and/or without calibrating the first sensor and/or the second sensor). In some embodiments, calibrating the camera is not based on comparing the first sensor data with the second sensor data but rather the calibrating occurs in response to a result of comparing the first sensor data with the second sensor data exceeding a threshold. In some embodiments, calibrating the camera includes geometrically calibrating and/or resectioning (e.g., estimates one or more parameters (e.g., intrinsic (e.g., focal length, optical center, principal point, and/or skew coefficient of the camera), extrinsic (e.g., rotation and/or orientation of the camera), and/or distortion (e.g., radial and/or tangential lens distortion) coefficient) of a lens and/or the camera (e.g., to correct for lens distortion, measure a size of an object in world units, and/or determine a location of the camera in an environment)).

In some embodiments, the second sensor is mounted inside of (and/or within) a camera body of the camera. In some embodiments, the first sensor and/or the first image sensor is not mounted inside of the camera body of the camera. In some embodiments, the first image sensor is mounted inside of the camera body of the camera. In some embodiments, the camera consists of a single camera body (e.g., the camera body). In some embodiments, the second sensor is coupled to the first image sensor. In some embodiments, the second sensor is not coupled to the first image sensor.

In some embodiments, calibrating the camera is based on motion (and/or data) detected via the first sensor, the second sensor, or any combination thereof. In some embodiments, calibrating the camera it not based on data (e.g., one or more images and/or video) detected via the first image sensor. In some embodiments, calibrating the camera is based on data (e.g., one or more images and/or video) detected via the first image sensor. In some embodiments, calibrating the camera depends and/or is based on motion but does not depend on and/or is not based on a current scene (e.g., a physical environment) (e.g., captured via the first image sensor and/or another image sensor different from the first image sensor). In some embodiments, calibrating the camera is not based on motion detected via the first sensor and/or the second sensor. In some embodiments, calibrating the camera is performed by first calibrating the second sensor using the first sensor data from the first sensor and/or the second sensor data from the second sensor. In some embodiments, after calibrating the second sensor, updated data detected via the second sensor is used to calibrate the camera (e.g., without using data detected via the first sensor).

In some embodiments, the computer system is in communication with a third sensor (e.g., the first sensor, the second sensor, the camera, the first image sensor, and/or another sensor different from the first sensor, the second sensor, the camera, the first image sensor). In some embodiments, the computer system detects, via the third sensor, motion (e.g., hitting an object such as a bump and/pr performing a sharp movement such as a turn and/or an abrupt stop) (e.g., of the computer system, the first sensor, the second sensor, the camera, the first image sensor, and/or the third sensor). In some embodiments, comparing the first sensor data with (and/or to) the second sensor data occurs in response to (and/or in accordance with and/or as a result of) a determination that the motion satisfies a first set of one or more criteria (e.g., exceeding a frequency, an amount, and/or a time threshold). In some embodiments, the camera is calibrated responsive to the determination that the motion satisfies a first set of one or more criteria. In some embodiments, the camera is not calibrated responsive to (and/or in accordance with and/or as a result of) a determination that the motion does not satisfy the first set of one or more criteria.

In some embodiments, the first sensor is configured to detect the same type of sensor data as the second sensor (e.g., the first sensor is the same type of sensor as the second sensor). In some embodiments, the second sensor has lower performance (e.g., detects sensor data with less accuracy and/or less often) than the first sensor. In some embodiments, the first sensor is a first IMU sensor. In some embodiments, the second sensor is a second IMU sensor. In some embodiments, the second IMU sensor has lower performance (and/or less accuracy) than the first IMU sensor.

In some embodiments, calibrating the camera includes identifying (and/or estimating, calibrating, re-assessing, correcting, modifying a stored value for, and/or updating a stored value for) a distance between the camera (and/or the first image sensor) and the first sensor.

In some embodiments, calibrating the camera includes identifying (and/or estimating, calibrating, re-assessing, correcting, modifying a stored value for, and/or updating a stored value for) an orientation between the camera (and/or the first image sensor) and the first sensor.

In some embodiments, after calibrating the camera and without detecting user input corresponding to a request to calibrate the camera, the computer system receives, from the first sensor (e.g., and not from the second sensor of the camera), (e.g., detects, via the first sensor) third sensor data (e.g., time-series and/or non-time-series data) (e.g., while the computer system is moving). In some embodiments, the third sensor data includes force data, angular rate data, and/or orientation data. In some embodiments, the third sensor data does not correspond to the camera. In some embodiments, the third sensor data includes and/or is IMU data. In some embodiments, the first sensor detects the third sensor data while the computer system is moving. In some embodiments, after calibrating the camera and without detecting user input corresponding to the request to calibrate the camera, the computer system receives, from the second sensor of the camera (e.g., and not from the first sensor), (e.g., detects, via the second sensor) fourth sensor data (e.g., time-series and/or non-time-series data) (e.g., while the computer system is moving). In some embodiments, the fourth sensor data includes force data, angular rate data, and/or orientation data. In some embodiments, the fourth sensor data corresponds to and/or is associated with the camera and/or the first image sensor. In some embodiments, the fourth sensor data includes and/or is IMU data. In some embodiments, the second sensor detects the fourth sensor data while the computer system is moving. In some embodiments, the third sensor data and/or the fourth sensor data is not image and/or video data. In some embodiments, after calibrating the camera, without detecting user input corresponding to the request to calibrate the camera, and after receiving the third sensor data and the fourth sensor data (and/or in response to receiving the third sensor data or the fourth sensor data), the computer system compares the third sensor data with (and/or to) the fourth sensor data (e.g., to determine a position (e.g., location and/or orientation) of the camera and/or the first image sensor with respect to the first sensor and/or a previous position of the camera and/or the first image sensor). In some embodiments, after calibrating the camera, without detecting user input corresponding to the request to calibrate the camera, and in response to comparing the third sensor data with the fourth sensor data, the computer system calibrates (e.g., based on comparing the third sensor data with the fourth sensor data) the camera (e.g., with respect to the first sensor, the second sensor, and/or a frame of a vehicle and/or the computer system) (and not calibrating and/or without calibrating the first sensor and/or the second sensor).

In some embodiments, the computer system detects a first event (e.g., user input, a predefined time has passed since last calibrating the camera, an upcoming maneuver to be performed by the computer system, hitting an object such as a bump, and/or performing a sharp movement such as a turn and/or an abrupt stop) (e.g., a particular event). In some embodiments, comparing the first sensor data with (and/or to) the second sensor data occurs in response to (and/or in accordance with and/or as a result of) detecting the first event. In some embodiments, the camera is calibrated in response to detecting the first event. In some embodiments, the camera is not calibrated in response to detecting a second event different and/or separate from the first event (e.g., the calibrating only occurs in response to some events). In some embodiments, comparing the first sensor data with (and/or to) the second sensor data does not occur in response to (and/or in accordance with and/or as a result of) detecting a second event different and/or separate from the first event (e.g., the comparing only occurs in response to some events).

In some embodiments, calibrating the camera includes identifying (and/or comparing, estimating, calibrating, re-assessing, correcting, modifying a stored value for, and/or updating a stored value for) a position of the camera (and/or the first image sensor) relative to a position of the first sensor.

In some embodiments, comparing the first sensor data with (and/or to) the second sensor data occurs while the computer system is (e.g., determined to be) moving (e.g., sensor data is not compared for purposes of calibration while the computer system is not moving and/or is stopped) (e.g., the camera is calibrated while the computer system is moving and is not calibrated while the computer system is not moving and/or is stopped).

In some embodiments, after calibrating the camera, the computer system captures, via the first image sensor, a first image (and/or a video) of an environment (e.g., a physical environment). In some embodiments, after capturing the first image of the environment, in accordance with a determination that a first set of one or more criteria is satisfied (e.g., that an object is at a first location within the environment, that the computer system should move in a particular direction, and/or that the environment is in a particular state), the computer system causes, based on the first image, a first physical movement (e.g., a first autonomous movement and/or a first physical maneuver, such as accelerating, decelerating, turning, and/or activating a light) to be performed. In some embodiments, after capturing the first image of the environment, in accordance with a determination that a second set of one or more criteria (e.g., that the object is at a second location within the environment, that the computer system should move in a particular direction, and/or that the environment is in a particular state), different from the first set of one or more criteria, is satisfied, the computer system causes, based on the first image, a second physical movement (e.g., a second autonomous movement and/or a second physical maneuver, such as accelerating, decelerating, turning, and/or activating a light), different from the first physical movement, to be performed. In some embodiments, before calibrating the camera in response to comparing the first sensor data with the second sensor data, the computer system captures, via the first image sensor, a second image (and/or a video) of an environment (e.g., a physical environment). In some embodiments, after capturing the second image of the environment and in accordance with a determination that a third set of one or more criteria is satisfied (e.g., that an object is at a first location within the environment, that the computer system should move in a particular direction, and/or that the environment is in a particular state), the computer system causes, based on the second image, a third physical movement (e.g., a third autonomous movement and/or a third physical maneuver, such as accelerating, decelerating, turning, and/or activating a light) to be performed. In some embodiments, after capturing the second image of the environment and in accordance with a determination that a fourth set of one or more criteria (e.g., that the object is at a second location within the environment, that the computer system should move in a particular direction, and/or that the environment is in a particular state), different from the third set of one or more criteria, is satisfied, the computer system causes, based on the second image, a fourth physical movement (e.g., a fourth autonomous movement and/or a fourth physical maneuver, such as accelerating, decelerating, turning, and/or activating a light), different from the third physical movement, to be performed.

In some embodiments, the first sensor data and the second sensor data are a first type of sensor data (e.g., the same type of sensor data, such as IMU data). In some embodiments, calibrating the camera includes estimating sensor data of the first type of sensor data at a location (e.g., a center of inertia, a middle, an edge, and/or a corner of an area corresponding to the computer system, and/or a location of a person within the computer system) different from a location of the first sensor and a location of the second sensor. In some embodiments, the location different from the location of the first sensor and the location of the second sensor does not include a sensor configured to detect the first type of sensor data. In some embodiments, calibrating the camera is based on creating a virtual sensor of the same type as the first sensor and/or the second sensor and estimating sensor data detected by the virtual sensor using the first sensor data and the second sensor data.

In some embodiments, calibrating camera includes: in accordance with a determination that the computer system is moving, calibrating a first set of one or more parameters (e.g., intrinsic (such as lens assembly and camera module) and/or extrinsic (such as where sensor is with respect to other objects and/or sensors) parameters) of the camera (and/or the first image sensor) (e.g., without calibrating the second set of one or more parameters described below) (e.g., with respect to a vehicle frame, a location, the first sensor, the second sensor, and/or another sensor different from the first sensor and the second sensor); and in accordance with a determination that the computer system is not moving (and/or is stopped), calibrating a second set of one or more parameters (e.g., intrinsic (such as lens assembly and camera module) and/or extrinsic (such as where sensor is with respect to other objects and/or sensors) parameters) of the camera (and/or the first image sensor) (e.g., with respect to a vehicle frame, a location, the first sensor, the second sensor, and/or another sensor different from the first sensor and the second sensor) without calibrating the first set of one or more parameters. In some embodiments, calibrating the camera includes, in accordance with a determination that the computer system is moving, the computer system calibrates a third set of one or more parameters (e.g., different from the first set of one or more parameters and/or the second set of one or more parameters) of the camera and/or the first image sensor. In some embodiments, calibrating the camera includes, in accordance with a determination that the computer system is not moving, the computer system calibrates the third set of one or more parameters of the camera. In some embodiments, the camera is only calibrated while the computer system is moving.

In some embodiments, calibrating the camera is based on the first sensor data, the second sensor data, and an image captured via the first image sensor (e.g., calibrating the camera includes (1) calibrating (e.g., IMU calibrating) based on the first sensor data and the second sensor data and (2) calibrating (e.g., image calibrating) based on the image captured via the first image sensor).

In some embodiments, the computer system receives, from a third sensor at a first location, first sensor data of a first type. In some embodiments, the computer system receives, from a fourth sensor, different from the third sensor, at a second location different from the first location, second sensor data of the first type. In some embodiments, the computer system receives a request for sensor data of the first type (e.g., IMU data, temperature data, and/or force data) at a third location different from the first location and the second location. In some embodiments, the third location does not include a sensor configured to detect sensor data of the first type. In some embodiments, the third location is not a center of inertia (e.g., of the computer system and/or a portion of the computer system). In some embodiments, the third location is a center of inertia (e.g., of the computer system and/or a portion of the computer system). In some embodiments, in response to receiving the request for sensor data of the first type, the computer system generates third sensor data of the first type by interpolating the first sensor data of the first type and the second sensor data of the first type. In some embodiments, the third sensor data of the first type is used to calibrate the camera.

In some embodiments, the first sensor and the second sensor are part of a distributed sensor network. In some embodiments, the first sensor is at a different location than the second sensor (e.g., with respect to the computer system).

The present disclosure has been laid out above referencing specific examples. However, such examples and descriptions are not intended limit the disclosure to those embodiments contained herein and are not intended to be exhaustive. Many modifications and variations are possible in view of the above teachings. The examples were chosen and described in order to best explain the principles of the techniques and their practical applications. An individual skilled in the art would thereby be enabled to utilize the present disclosure as laid out, and enabled to best utilize the techniques and various examples with various modifications as are suited to the particular use contemplated.

While the present disclosure and examples are accompanied by references to specific drawings, it is to be noted that various changes and modifications will become apparent to those skilled in the art. Such changes and modifications are to be understood as being included within the scope of the disclosure and examples as defined by the claims.

As described above, the present technology improves how a device interacts with a user by gathering and using data from various available sources. In some embodiments, this data can include personal data (e.g., demographic data, location-based data, telephone numbers, email addresses, home addresses, or any other identifying information) that uniquely identifies or can be used to contact or locate a specific person.

The present disclosure recognizes that the use of personal information data can enhance a user's experience while using a computer system. For example, personal information data can be used for the benefit of users by changing how a computer system interacts with a user. Thus, enabling better user interactions. Additionally, other uses for personal information data that benefit the user are also contemplated by the present disclosure.

The present disclosure further contemplates that the use of a user's personal information data, in the present technology, impacts the user's privacy. As well, that the entities responsible for the collection, analysis, disclosure, transfer, storage, or other use of such personal information data will comply with well-established privacy policies and/or privacy practices. Particularly, the implementation and maintenance of industry or government standard privacy policies and practice is required for entities to keep personal information data private and secure. For example, entities should only collect personal information data for reasonable and legitimate uses within the entity and should not be shared or sold to outside entities. Additionally, the collection of personal information data should only occur after receiving information consent from the target users. Further, once such personal information data has been obtained, entities should take necessary steps to secure the collected personal information data from improper access or use. Therefore, entities should ensure their practices follow their established privacy policies and procedures, either internally or through third party evaluations to certify their practices.

Alternatively, the present disclosure also ensures that the functionality of the disclosed embodiments is not rendered inoperable due to the lack of all or a portion of such personal information data. The present disclosure considers embodiments that allow users to selectively block the use of, or access to, personal information data. Such inability to access personal information data can be provided through hardware components and/or software elements. For example, in the case of image capture, the present technology can be configured to allow users to select to “opt in” or “opt out” of participation in the collection of personal information data during registration for services. Thus, while the present disclosure is broadly directed to the use of personal information data in one or more various disclosed embodiments, the present disclosure also contemplates that the various embodiments can also be implemented without the use of such personal information data. For example, content can be displayed to users by inferring location based on non-personal information data or a bare minimum amount of personal information, such as the content being requested by the device associated with a user or other non-personal information.

What is claimed is:

1. A method, comprising:
at a computer system that is in communication with a first sensor and a camera that includes a first image sensor and a second sensor different from the first sensor, wherein the first sensor and the second sensor do not include an image sensor:
receiving, from the first sensor, first sensor data;
receiving, from the second sensor of the camera, second sensor data;
after receiving the first sensor data and the second sensor data, comparing the first sensor data with the second sensor data; and
in response to comparing the first sensor data with the second sensor data, calibrating the camera.

2. The method of claim 1, wherein the second sensor is mounted inside of a camera body of the camera.

3. The method of claim 1, wherein calibrating the camera is based on motion detected via the first sensor, the second sensor, or any combination thereof, and wherein calibrating the camera it not based on data detected via the first image sensor.

4. The method of claim 1, wherein the computer system is in communication with a third sensor, the method further comprising:
detecting, via the third sensor, motion, wherein comparing the first sensor data with the second sensor data occurs in response to a determination that the motion satisfies a first set of one or more criteria.

5. The method of claim 1, wherein the first sensor is configured to detect the same type of sensor data as the second sensor, and wherein the second sensor has lower performance than the first sensor.

6. The method of claim 1, wherein calibrating the camera includes identifying a distance between the camera and the first sensor.

7. The method of claim 1, wherein calibrating the camera includes identifying an orientation between the camera and the first sensor.

8. The method of claim 1, further comprising:
after calibrating the camera and without detecting user input corresponding to a request to calibrate the camera:
receiving, from the first sensor, third sensor data;
receiving, from the second sensor of the camera, fourth sensor data;
after receiving the third sensor data and the fourth sensor data, comparing the third sensor data with the fourth sensor data; and
in response to comparing the third sensor data with the fourth sensor data, calibrating the camera.

9. The method of claim 1, further comprising:
detecting a first event, wherein comparing the first sensor data with the second sensor data occurs in response to detecting the first event.

10. The method of claim 1, wherein calibrating the camera includes identifying a position of the camera relative to a position of the first sensor.

11. The method of claim 1, wherein comparing the first sensor data with the second sensor data occurs while the computer system is moving.

12. The method of claim 1, further comprising:
after calibrating the camera, capturing, via the first image sensor, a first image of an environment; and
after capturing the first image of the environment:
in accordance with a determination that a first set of one or more criteria is satisfied, causing, based on the first image, a first physical movement to be performed; and
in accordance with a determination that a second set of one or more criteria, different from the first set of one or more criteria, is satisfied, causing, based on the first image, a second physical movement, different from the first physical movement, to be performed.

13. The method of claim 1, wherein the first sensor data and the second sensor data are a first type of sensor data, and wherein calibrating the camera includes estimating sensor data of the first type of sensor data at a location different from a location of the first sensor and a location of the second sensor.

14. The method of claim 1, wherein calibrating camera includes:
in accordance with a determination that the computer system is moving, calibrating a first set of one or more parameters of the camera; and
in accordance with a determination that the computer system is not moving, calibrating a second set of one or more parameters of the camera without calibrating the first set of one or more parameters.

15. The method of claim 1, wherein calibrating the camera is based on the first sensor data, the second sensor data, and an image captured via the first image sensor.

16. The method of claim 1, further comprising:
receiving, from a third sensor at a first location, first sensor data of a first type;
receiving, from a fourth sensor, different from the third sensor, at a second location different from the first location, second sensor data of the first type;
receiving a request for sensor data of the first type at a third location different from the first location and the second location, wherein the third location does not include a sensor configured to detect sensor data of the first type; and
in response to receiving the request for sensor data of the first type, generating third sensor data of the first type by interpolating the first sensor data of the first type and the second sensor data of the first type.

17. The method of claim 1, wherein the first sensor and the second sensor are part of a distributed sensor network, and wherein the first sensor is at a different location than the second sensor.

18. A non-transitory computer-readable storage medium storing one or more programs configured to be executed by one or more processors of a computer system that is in communication with a first sensor and a camera that includes a first image sensor and a second sensor different from the first sensor, wherein the first sensor and the second sensor do not include an image sensor, the one or more programs including instructions for:
receiving, from the first sensor, first sensor data;
receiving, from the second sensor of the camera, second sensor data;
after receiving the first sensor data and the second sensor data, comparing the first sensor data with the second sensor data; and
in response to comparing the first sensor data with the second sensor data, calibrating the camera.

19. A computer system configured to communicate with a first sensor and a camera that includes a first image sensor and a second sensor different from the first sensor, wherein the first sensor and the second sensor do not include an image sensor, comprising:
one or more processors; and
memory storing one or more programs configured to be executed by the one or more processors, the one or more programs including instructions for:
receiving, from the first sensor, first sensor data;
receiving, from the second sensor of the camera, second sensor data;
after receiving the first sensor data and the second sensor data, comparing the first sensor data with the second sensor data; and
in response to comparing the first sensor data with the second sensor data, calibrating the camera.
